(19) United States
(12) Patent Application Publication
(10) Pub. No.: US 2024/0253501 A1
(43) Pub. Date: Aug. 1, 2024

(54) UNDERWATER CHARGING

(71) Applicant: BAE SYSTEMS plc, London (GB)

(72) Inventors: Lawrence Edward Clabburn, Barrow-in-Furness Cumbria (GB); Simon Phillip Newby, Barrow-in-Furness Cumbria (GB); David Charles Alexander Ritchie, Barrow-in-Furness Cumbria (GB)

(73) Assignee: BAE SYSTEMS plc, London (GB)

(21) Appl. No.: 18/563,539

(22) PCT Filed: May 25, 2022
(86) PCT No.: PCT/GB2022/051310

§ 371 Date: Nov. 22, 2023

(30) Foreign Application Priority Data
Jun. 2, 2021 (EP) 21275068.1
Jun. 2, 2021 (GB) 2107862.1

(51) Int. Cl. B60L 53/36; B60L 53/16; B60L 53/18; B63G 8/00; B63G 8/39

(52) U.S. Cl. CPC B60L 53/36; B60L 53/16; B60L 53/18; B63G 8/001; B63G 8/39; B60L 2200/32; B63G 2008/004

(57) ABSTRACT

Disclosed is an underwater charging arrangement comprising a first connector coupled to a daughter craft and a second connector coupled to a mother craft, wherein the first and second connectors are arranged to couple underwater to facilitate the transfer of energy from the mother craft to the daughter craft.

### FIELD

The present invention relates to charging an underwater vessel. The underwater vessel is typically a relatively small submarine craft which is charged from a relatively large submarine craft.

### BACKGROUND

Typically, submarine craft are required to surface and return to dock to be re-fueled. However, some submarine craft, such as nuclear-powered submarine craft, are able to stay submerged and away from dock for extended periods. Nuclear-powered submarines have, in principle, excess energy which can be transferred to other submarine craft. However, in practice

### SUMMARY

According to an aspect of the present invention, there is provided an underwater charging arrangement comprising a first connector coupled to a daughter craft and a second connector coupled to a mother craft, wherein the first and second connectors are arranged to couple underwater to facilitate the transfer of energy from the mother craft to the daughter craft.

In an embodiment, each of the mother and daughter craft is a submarine vessel.

In an embodiment, the second connector is located at a free end of a line whose other end is tethered to the mother craft.

In an embodiment, the second connector is located within a drogue.

In an embodiment, the line, when not in a charging configuration, is stowed within the mother craft.

In an embodiment, the first connector is located at a free end of a probe arranged to extend from a surface of the daughter craft.

In an embodiment, the probe, when not in a charging configuration, is stowed within the daughter craft.

In an embodiment, coupling aids are provided proximal to the first and second connectors.

In an embodiment, the coupling aids comprise one or more of SONAR and LIDAR emitters and receivers.

In an embodiment, one or more of the first and second connectors is provided with an actuator to assist with coupling the first and second connectors.

In an embodiment, the first and second connectors comprise either “wet mate” connectors or connectors having an oil purge capability.

According to an aspect of the present invention, there is provided method of charging an internal power source of a daughter craft from a mother craft, comprising the steps of: deploying a line from the mother craft; manoeuvring the daughter craft, such that a probe extending from the daughter craft couples with a drogue at a free end of the line; supplying power from the mother craft to the daughter craft via the line.

### BRIEF DESCRIPTION OF THE FIGURES

Embodiments of the invention will now be described by way of example only with reference to the figures, in which:

FIG. 1 shows an overview of an underwater charging situation according to an embodiment of the present invention;

FIG. 2 shows details of a probe on a daughter craft according to an embodiment of the present invention;

FIG. 3 shows a drogue attached to a mother craft according to an embodiment of the present invention;

FIG. 4 shows mother and daughter craft in a coupled configuration, according to an embodiment of the present invention;

FIG. 5 shows a close-up detail of a probe and drogue in a pre-coupled configuration according to an embodiment of the present invention;

FIG. 6 shows a close-up detail of a probe and drogue in a coupled configuration according to an embodiment of the present invention; and

FIG. 7 is a flowchart illustrating an embodiment of the invention.

### DETAILED DESCRIPTION

Embodiments of the present invention relate to underwater charging arrangements of particular use in recharging or refuelling a daughter craft from a mother craft.

Underwater craft which are fueled by rechargeable battery cells are known in the art. Such craft are typically deployable for a period of time which is dictated by the amount of charge available. Once the charge in the cells is near depletion, then the craft must somehow recharge its cells. This can be done by returning to dock or some other base to be recharged. Alternatively, the craft can make use of an on-board diesel generator to recharge the cells. This requires the craft to be on or near the surface and to deploy an exhaust and intake mast, which is undesirable as it can reveal the craft's location.

It is further known to provide a fixed charging station underwater, the location of which is known to the craft. When charging is required, the craft navigates to the station, docks with it, and charging is performed while the craft is stationary with respect to the charging station. A problem with such an arrangement is that such charging points are necessarily limited and do not permit the craft to navigate freely, since it must always be within range of such a charging point. Further, some such charging points make use of inductive charging which is slow and inefficient, although other types are available.

It is further known for the craft requiring recharging (the daughter craft) to dock with another craft (the mother craft). However, this poses risks and can be difficult to achieve safely.

However, it is often necessary to deploy a submarine craft for an extended period of time, in excess of the time permitted by a single charge of the craft's battery cells. In the absence of fixed charging points, or docking with another craft, there is currently no feasible means to refuel the craft while away from base.

In the following, the terms refuel and recharge are used interchangeably and refer to the replenishing of the daughter craft's internal battery cells.

Submarine craft are used for a variety of operations. Such operations can include underwater surveys for the purposes of: pipe or cable laying; environmental monitoring; geological research; fisheries research and monitoring; and military operations. Whatever the mission of the submarine craft, there are occasions when extended time away from base is required and the limit imposed by the craft's battery cells can be a decisive factor.

Embodiments of the present invention refer to the submarine craft to be recharged as the daughter craft, and the submarine craft which provides the charging facility as the mother craft.

The daughter craft is typically smaller than the mother craft.

In an embodiment, the daughter craft is fueled by rechargeable battery cells. These are preferable high capacity, rapidly chargeable, cells, such as Li—ion cells, although any rechargeable battery technology can be used.

In an embodiment, the mother craft is fueled by a nuclear reactor, which offers almost limitless amounts of power. The recharging capacity is provided by energy produced from the nuclear reactor of the mother craft.

The mother craft is typically many times larger than the daughter craft and may carry a crew numbered in tens. The daughter craft may be autonomous and may carry no crew or just a few personnel.

A particular problem in facilitating underwater charging, is ensuring that a good connection is made between the two craft involved.

In the case of charging the daughter craft from a nuclear-powered submarine, it is important to maintain a safe distance between the craft, in case of accidental impact. This is one of the reasons why it is not desirable to attempt to dock the daughter craft on the mother craft e.g. by the use of a dock area on an upper surface of the mother craft.

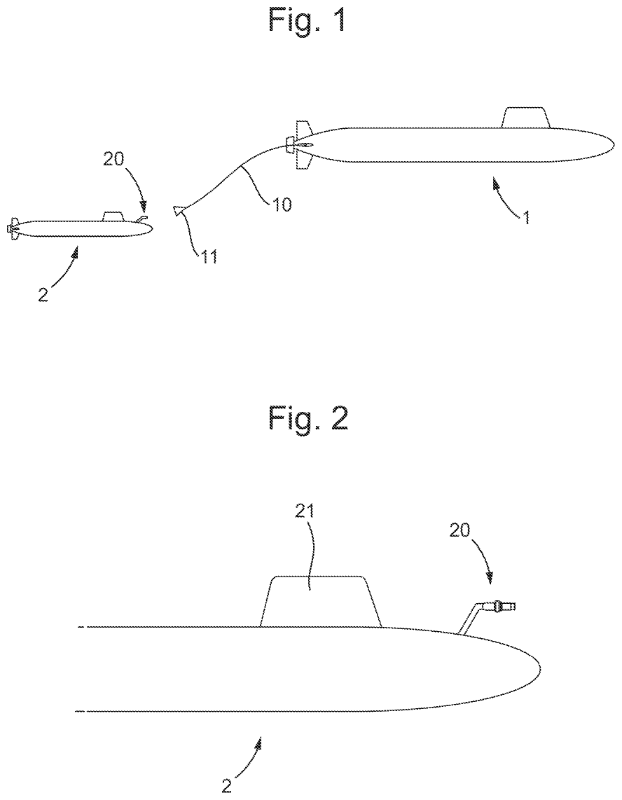

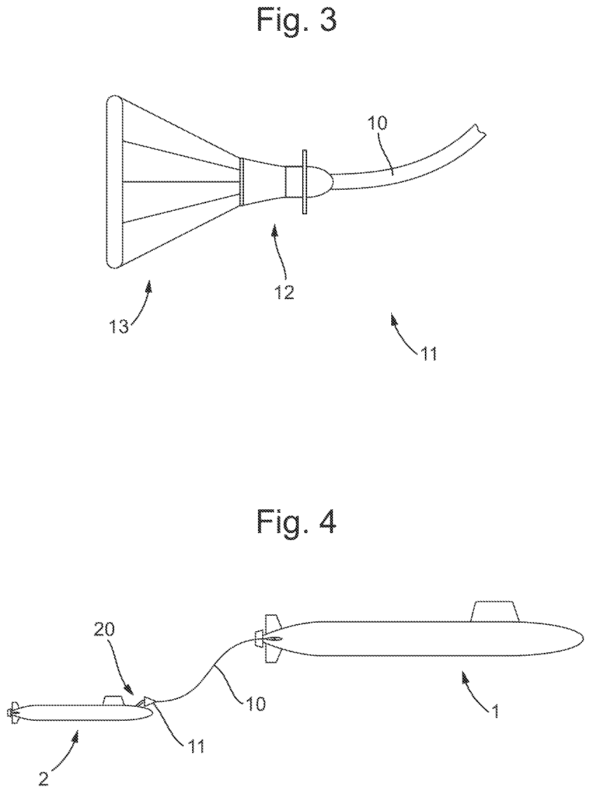

In order to address this issue, an embodiment of the invention, shown in FIG. 1, uses a line 10 deployed from the mother craft 1 which is terminated in a drogue 11. The drogue 11 is shown in more detail in FIG. 3 and takes the form of a basket or, more accurately, a shuttlecock. The drogue 11 comprises a flared region 13 which defines a relatively wide opening tapering towards a connector 12, which is where an electrical connection is made between the mother and daughter craft.

FIG. 1 also shows the daughter craft 2, which is significantly smaller than the mother craft 1. However, this need not be the case and the daughter craft could be the same size as, smaller than, or larger than the mother craft. In an embodiment, the daughter craft is entirely autonomous and has no crew onboard.

FIGS. 1 and 2 show the daughter craft and, protruding from the front thereof, is a probe 20. The probe 20 is located on or near the fore body of the craft. The probe 20 may be permanently deployed as shown or, preferably, can be stowed when not required and only deployed as shown in order to receive charge.

When charging is required, the mother craft 1 deploys the line 10, terminated in drogue 11. The line may extend several metres or tens of metres behind the mother craft 1. The basket-like arrangement of the drogue 11 provides some stability as the mother craft 1 moves through the water and prevents the drogue from moving about uncontrollably. Even with the mother craft moving forwards, the drogue 11 maintains a relatively stable position with respect to the mother craft 1. This stability is helpful in ensuring a reliable coupling operation with the daughter craft 2.

Once the drogue 11 has been deployed on line 10, the daughter craft 2 approaches the drogue 11 and manoeuvres itself such that probe 20 is able to couple with the drogue 11. Once coupling has been achieved, then the mother and daughter craft remain connected for as long as is required to provide sufficient charge. This is illustrated in FIG. 4.

Both mother 1 and daughter 2 craft maintain a forward velocity during the charging operation. This is since it can be difficult to maintain a submarine craft in a truly stationary position and forward velocity is to be preferred.

The mother and daughter craft should ideally maintain the same forward velocity, but small differences can be accommodated, to some extent, by means of slack in the line 10.

The line 10, as well as carrying power connections for charging the battery cells of the daughter craft 2, may also carry a data connection to permit tethered communication between the two craft. This data connection can carry information related to course and speed to ensure that the trajectories of the two craft match for the duration of the charging operation. The data connections can also carry other operational data, such as charge required, current capacity, details of remaining charge time as well as other data related to the charging operation. The data connection can also carry any other data which is required to be passed in either direction between the two craft. For instance, if the daughter craft has been submerged for some time, perhaps carrying out a survey of the sea bed, it can upload its data to the mother craft for safe-keeping and/or onward transmission, as required.

The mother craft 1 generally has a much larger power capacity than the daughter craft 2 and, in the case of nuclear powered craft, the amount of energy which may be produced and passed to the daughter craft is effectively limitless. As such, energy may be transferred to the daughter craft 2 without adversely affecting the operations of the mother craft 1.

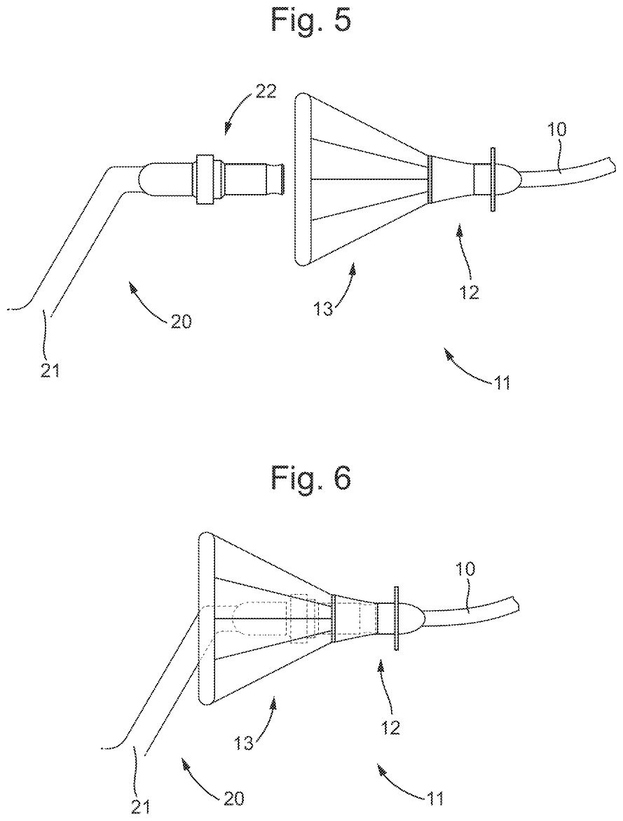

FIGS. 5 and 6 show, respectively, the situation immediately pre-coupling and in the coupled state. In FIG. 5, the probe 20 is positioned proximal to the tapered opening of the drogue 11. The probe 20 has a support shaft 21 which is substantially rigid and maintains the probe in a fixed position.

The frontmost portion of the probe 20 houses one half of a mating connector 22, which couples with a corresponding complementary connector 12 in the drogue 11.

There are various known options for making an underwater connection. Two types, in particular, are particularly suitable. The first is manufactured by Siemens and is known by the brand name “SpecTRON”. In these connectors, an oil purge can be carried out within the connector to remove any sea water near the contacts. The oil purge is an inherent feature of the device and so these connectors can be used in a substantially off the shelf manner.

The second type is manufactured by Northrop Grumman and are known as “wet mate connectors”. These connectors are made from exotic metals and are able to form safe electrical connections whilst surrounded by water. This is due to a reaction which occurs between the exotic metal and the sea water to from an insulator, which therefore protects the electrical connection.

By means of either of these connectors, a suitable electrical charging connection can be made underwater. Other types are available and the use of either of these types is not to be considered limiting, merely as illustrative

In use, connection between mating halves of the connector can be achieved by the force of the mating halves coming together. If additional force is required, then it may be necessary to provide further actuation means. Such an actuation means can take many forms, such as an electrically or hydraulically actuated locking ring, which can provide a suitable locking action to one or both of the mating halves.

In order to make the connection between probe 20 and drogue 11, additional connection aids may be provided. The visibility underwater can vary across a wide range and, in any event, there is no window through which a navigator could steer the vessels toward coupling in any event. As such, the basket 13 of the drogue 11 may be provided with SONAR transponders or “pingers” which emit signals which can be picked up by corresponding sensor on the probe, allowing accurate alignment and coupling to take place. As well as, or instead of, SONAR techniques, the basket 13 and probe 20 may be provided with a LIDAR emitter and receiver to aid navigation. Certain blue/green-coloured LIDAR emitters are found to work well in underwater settings.

Once connection is made, the two craft remain coupled for as long as is necessary to sufficiently recharge the cells of the daughter craft. After this, the connection is unmade and the two craft can continue independently. On the mother craft 1, the line 10 is withdrawn back into the craft and on the daughter craft, the probe can be withdrawn and stowed, if required.

A further advantage of the probe and drogue coupling method set out above is that if there is an emergency situation where either craft is required to take evasive action, such as returning to the surface rapidly by e.g. blowing the ballast tank, then the probe and drogue can be rapidly disconnected. In contrast, if the daughter craft were docked on the surface of the mother craft, then such a manoeuvre would have the potential to be highly dangerous to both vessels.

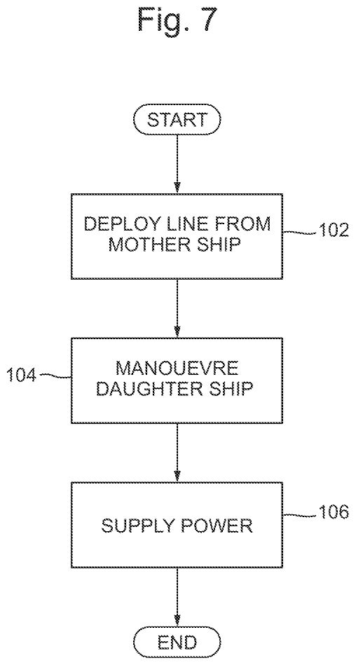

FIG. 7 shows a flowchart which depicts a method according to an embodiment of the invention. At step 102, the mother ship 1 deploys line 10. At step 104, the daughter ship 2 manoeuvres itself to approach the drogue 11 with its probe 20.

Once coupled, at step 106 power is supplied from the mother ship 1 to the daughter ship 2.

Once this process is ended, the connection is unmade and each craft can continue independently.

By virtue of embodiments of the invention set out above, it is possible to safely and efficiently recharge the battery cells of an underwater craft from another, mother, craft in a manner which allows the craft to remain underwater at all times and without the need to dock with the mother craft, locate and connect to an underwater charging location or return to base. By use of an embodiment of the invention, the underwater craft can effectively remain underwater for a greatly extended period.

1. An underwater charging arrangement comprising a first connector and a second connector, the first connector coupled to a daughter craft and the second connector coupled to a mother craft, wherein the first and second connectors are arranged to couple underwater to facilitate the transfer of energy from the mother craft to the daughter craft.

2. The arrangement of claim 1, wherein each of the mother craft and the daughter craft is a submarine vessel.

3. The arrangement of claim 1, wherein the second connector is located at a free end of a line whose other end is tethered to the mother craft.

4. The arrangement of claim 3, wherein the second connector is located within a drogue.

5. The arrangement of claim 3, wherein the line, when not in a charging configuration, is stowed within the mother craft.

6. The arrangement of claim 1, wherein the first connector is located at a free end of a probe arranged to extend from a surface of the daughter craft.

7. The arrangement of claim 6, wherein the probe, when not in a charging configuration, is stowed within the daughter craft.

8. The arrangement of claim 1, wherein coupling aids are provided proximal to the first and second connectors.

9. The arrangement of claim 8, wherein the coupling aids comprise a SONAR emitter and a SONAR receiver, or a LIDAR emitter and a LIDAR receiver, or both SONAR and LIDAR emitters and receivers.

10. The arrangement of claim 1, wherein one or more of the first and second connectors is provided with an actuator to assist with coupling the first and second connectors.

11. The arrangement of claim 1, wherein the first and second connectors comprise are wet-mate connectors.

12. A method of charging an internal power source of a daughter craft from a mother craft, the method comprising:
deploying a line from the mother craft;
manoeuvring the daughter craft, such that a probe extending from the daughter craft couples with a drogue at a free end of the line; and
supplying power from the mother craft to the daughter craft via the line.

13. The method of claim 12, wherein the other end of the line is tethered to the mother craft, and the line is stowable within the mother craft when not being used to supply power to the daughter craft.

14. The arrangement of claim 4, wherein the line, when not in a charging configuration, is stowed within the mother craft.

15. The arrangement of claim 1, wherein the first and second connectors comprise are connectors having an oil purge capability.

16. An underwater charging system comprising:
a mother craft;
a daughter craft;
a probe coupled to the daughter craft; and
a line coupled to a mother craft at one end and having a drogue at the other end;
wherein the probe and drogue are arranged to couple underwater to facilitate the transfer of energy from the mother craft to the daughter craft.

17. The system of claim 16, wherein each of the mother craft and the daughter craft is a submarine vessel.

18. The system of claim 16, wherein the probe is movable between a stowed position and a deployed position, at the daughter vessel.

19. The system of claim 16, wherein the line and drogue are stowable within the mother craft.

20. The system of claim 16, comprising a SONAR or LIDAR coupling aid to facilitate coupling of the probe and drogue.
